(19) United States
(12) Patent Application Publication
(10) Pub. No.: US 2014/0078072 A1
(43) Pub. Date: Mar. 20, 2014

(54) Method and Apparatus Pertaining to the Display and Acceptance of Predicted Text

(71) Applicant: RESEARCH IN MOTION LIMITED, Waterloo (CA)

(72) Inventor: Arjun Singh RAI BHATTI, Ottawa (CA)

(73) Assignee: RESEARCH IN MOTION LIMITED, Waterloo (CA)

(21) Appl. No.: 13/621,366

(22) Filed: Sep. 17, 2012

(51) Int. Cl. G06F 3/02; G06F 3/041; G09G 5/00

(52) U.S. Cl. 345/173; 345/156; 345/184

(57) ABSTRACT

An electronic device is configured to display text as entered by a user and to provide predicted words in response to that entered text. The device displays only one of the predicted words on the display at a time, in-line with the text being entered by the user, to thereby provide an opportunity for the user to accept the one predicted word. Upon detecting the user's assertion of a button that is separate from the display, the device accepts the one predicted word as part of the entered text. By one approach, the aforementioned button has only the one dedicated function and may comprise, for example, a discrete mechanical button. By one approach, that button is disposed on a side of the device's housing that is opposite the side that presents the aforementioned display.

### FIELD OF TECHNOLOGY

The present disclosure relates to the entry of alphanumeric text into an electronic device and more particularly to predicted text.

### BACKGROUND

Numerous electronic devices offer the user an ability to enter alphanumeric text on a character-by-character basis. User-input interfaces in these regards include but are not limited to physical keyboards as well as virtual keyboards (i.e., keyboards that are displayed on a touch-sensitive display that offers keys that a user can individually select by tapping the display at the location of the desired key). Full-size keyboards can accommodate relatively high-speed text input with reasonably proficient typists typically achieving input rates of dozens of words per minute.

Smaller keyboards (such as those often found on so-called smartphones, pad/tablet-styled devices, and so forth), however, will typically not accommodate ordinary typing practices and often require the user to instead employ either a hunt-and-peck style of typing or so-called thumb typing. Accordingly, the rate at which a typical typist can enter text using a smaller keyboard is usually considerably lower than the ordinary rates that are associated with full-size mechanical keyboards.

Some electronic devices attempt to shorten the number of characters that a user must enter by offering the user predicted text candidates. For example, if the user types the letter “t,” the device may simultaneously display a listing of possible words that the user might be intending to type, such as the words “there,” “the,” that,” and “those.”When the device successfully displays the intended word, the user can select that word (for example, by tapping the proffered word on a touchscreen display). Upon selecting the word, the selected word is added to the user's previously entered text and the user can continue entering characters to complete their message.

While useful to a degree, prior-art approaches in these regards are not necessarily well suited to all application settings. Electronic devices that employ a physical keyboard, for example, are not always able to usefully employ these prior-art approaches to good effect. Similarly, devices that offer only a relatively small display are also often unduly hampered in these regards.

### BRIEF DESCRIPTION OF THE DRAWINGS

FIG. 1 is a flow diagram in accordance with the disclosure.

FIG. 2 is a block diagram in accordance with the disclosure.

FIG. 3 is a perspective schematic representation in accordance with the disclosure.

FIG. 4 is a bottom plan schematic representation in accordance with the disclosure.

FIG. 5 is a perspective schematic representation in accordance with the disclosure.

FIG. 6 is a perspective schematic representation in accordance with the disclosure.

FIG. 7 is a block diagram in accordance with the disclosure.

### DETAILED DESCRIPTION

The following describes an apparatus and method pertaining to an electronic device configured to display text as entered by a user and to provide predicted words in response to that entered text. The device then displays only one of the predicted words on the display at a time, in line with the text being entered by the user, to thereby provide an opportunity for the user to accept the one predicted word. Upon detecting the user's assertion of a button that is separate from the display, the device accepts the one predicted word as part of the entered text.

By one approach, the aforementioned button has only the one dedicated function and may comprise, for example, a discrete mechanical button. By one approach, that button is disposed on a side of the device's housing that is opposite the side that presents the aforementioned display. So configured, the user can easily locate and assert this button without averting their eyes from the displayed text and/or the keyboard.

These teachings are highly flexible in practice. For example, by one approach a predicted portion of the one displayed predicted word is displayed differently than the text already input (i.e., as directly input or as otherwise accepted) by the user. This difference might comprise, for example, using a different color to display the predicted portion of the word as compared to the color used to display the user-entered portion of the word.

So configured, many significant benefits of predicted text entry can be enjoyed while nevertheless employing a physical keyboard and/or a diminutively-sized display. Of course, these teachings can also be utilized in conjunction with generously-sized displays and/or virtual keyboards as well and can to some significant extent offer a more-intuitive feel to the user resulting, at least in part, from not requiring the user to avert their eyes in order to locate and/or scan a list of candidate predicted words.

For simplicity and clarity of illustration, reference numerals may be repeated among the figures to indicate corresponding or analogous elements. Numerous details are set forth to provide an understanding of the embodiments described herein. The embodiments may be practiced without these details. In other instances, well-known methods, procedures, and components have not been described in detail to avoid obscuring the embodiments described. The description is not to be considered as limited to the scope of the embodiments described herein.

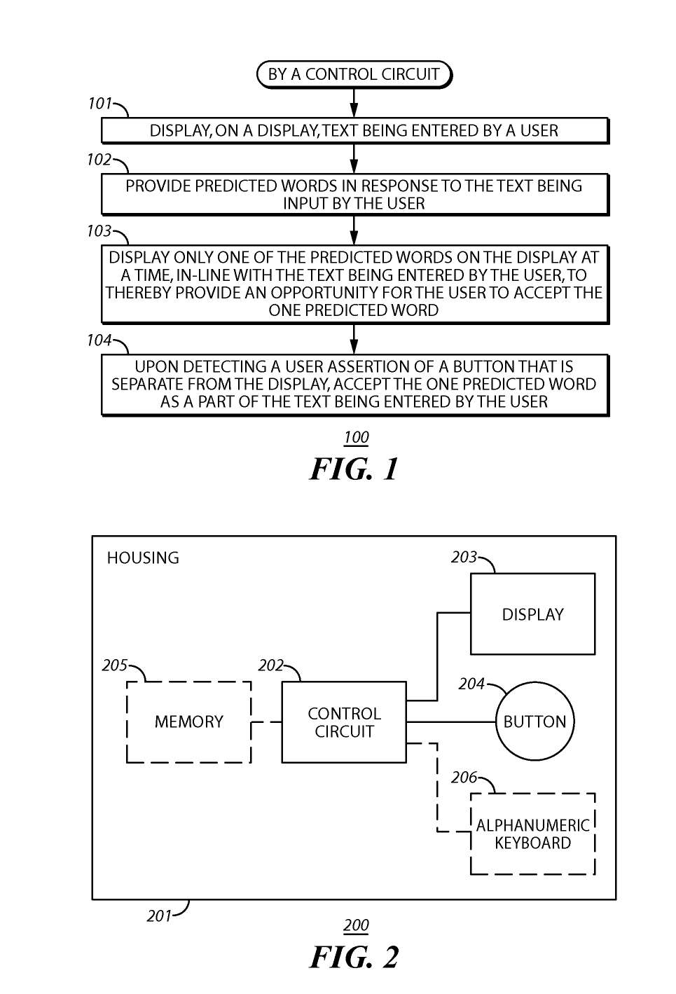

FIG. 1 presents a process 100 that accords with many of the present teachings. For the purpose of an illustrative example it will be presumed here that a control circuit of choice carries out this process 100. By way of further illustrative example (and without intending any particular limitations in these regards) FIG. 2 depicts an apparatus 200 having such a control circuit 202. Such a control circuit 202 can comprise a fixed-purpose hard-wired platform or can comprise a partially or wholly programmable platform. These architectural options are well known and understood in the art and require no further description here.

This apparatus 200 can comprise, for example, a portable electronic device such as, but not limited to, a portable communications device such as a so-called smartphone. In this illustrative example the apparatus 200 further includes a housing 201 that supports the aforementioned control circuit 202 as well as a display 203 and a button 204. The control circuit 202 operably couples to the display 203 in order to control the displayed content (and also to receive user input when the display 203 comprises a touchscreen display). The control circuit 202 also operably couples to the button 204 for purposes disclosed in more detail herein.

By one approach this apparatus 200 can further include a memory 205 that operably couples to the control circuit 202. The memory 205 may be integral to the control circuit 202 or can be physically discrete (in whole or in part) from the control circuit 202 as desired. This memory 205 can also be local with respect to the control circuit 202 (where, for example, both share a common circuit board, chassis, power supply, and/or housing (201)) or can be partially or wholly remote with respect to the control circuit 202 (where, for example, the memory 205 is physically located in another facility, metropolitan area, or even country as compared to the control circuit 202).

Such a memory can serve to store, for example, a plurality of words that can serve as predicted text. This memory 205 can also serve, for example, to non-transitorily store computer instructions that, when executed by the control circuit 202, cause the control circuit 202 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

This apparatus 200 will also accommodate the optional inclusion of a physical alphanumeric keyboard 206 such as any of a variety of physical keyboards that are known in the art. Such a keyboard 206 can also operably couple to the control circuit 202 to permit the latter to receive textual content as input by a user via the keyboard 206.

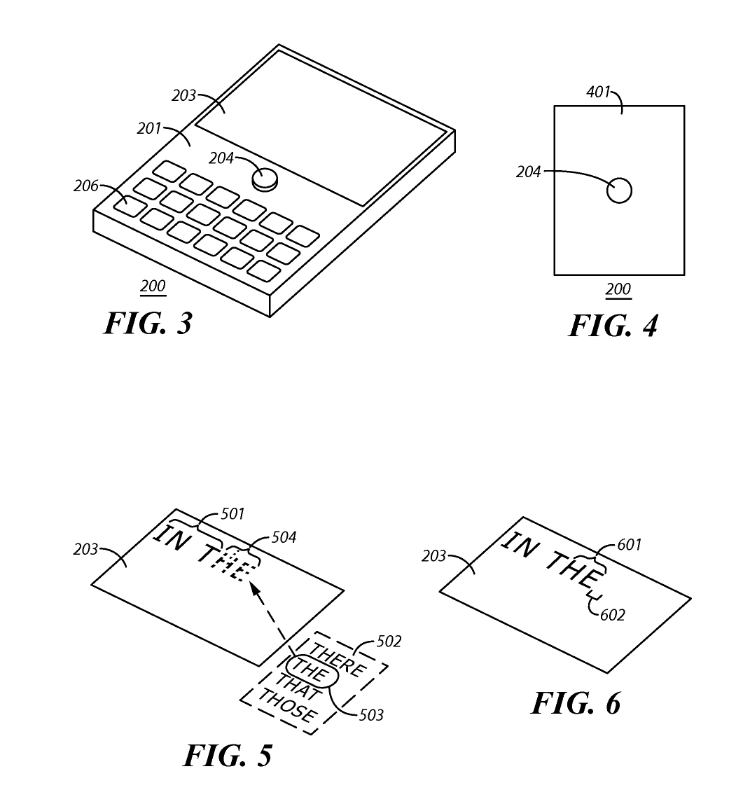

FIG. 3 provides an illustrative example of such an apparatus 200 where the aforementioned display 203, button 204, and keyboard 206 all appear on a front side of the apparatus 200. In this particular example the button 204 is physically separate from both the display 203 as well as the keyfield of the keyboard 206. This button 204 can comprise, for example, a discrete mechanical button such as any of a wide variety of push buttons that are known in the art. This button 204 could also comprise a virtual button that appears on a display separate from the display 203 noted above. By one approach this button 204 has only one dedicated function as described herein.

In the example just provided the button 204 is disposed on a same side of the housing 201 that includes the display 203. These teachings will accommodate other approaches in these regards, however. For example, as shown in FIG. 4, the button 204 can be disposed on a side 401 of the housing 201 that is opposite the display 203 (in this case, the backside of the housing 201). The particular location of the button 204, as well as its size and shape, can be varied as desired to meet the particular needs and/or opportunities as tend to characterize a given application setting.

Referring again to FIG. 1 and also to FIG. 5, this process 100 provides for having the control circuit 202 display, on the aforementioned display 203, text 501 being entered by the user (typically in more-or-less real time) via, for example, the aforementioned keyboard 206. In the illustrative example shown in FIG. 5, the user has entered, so far, the letters for the word “in,” a following space, and the letter “t.”

The process 100 then has the control circuit 202 provide 102 predicted words 502 in response to that input text 501. Note that this “providing” 102 does not entail actually displaying or otherwise presenting these predicted words 502 to the user. Instead, this “providing” 102 activity occurs in the processing background. In this illustrative example these predicted words 502 include the words “there,” “the,” “that,” and “those.” There are various text-prediction approaches known in the art. As the present teachings are not particularly sensitive to any specific choices in such regards, further elaboration in these regards is not provided here for the sake of brevity.

The process 100 then has the control circuit 202 display 103 (on the display 203) only one 503 of the predicted words 502 at a time (in this case, the word “the”). The particular word so chosen can be selected using any of a variety of selection mechanisms. By one simple approach, for example, the control circuit 202 may simply select the word 503 at random. More typically, the control circuit 202 may have access to probability information that weights or otherwise grades or ranks the likelihood of any particular one of the candidate predicted words 502 being the correct word. Such likelihoods may be determined, for example, by considering the user's historically-selected words and/or the overall context of the already-entered text.

By one approach, and as illustrated in FIG. 5, the one predicted word 503 is displayed in-line with the text 501 being entered by the user. In this particular case, the predicted portion 504 of the predicted word 503 is displayed in-line and in conjunction with the already entered letter(s) 501.

If desired, the prediction portion 504 of the one predicted word 503 is displayed differently than the already-entered text 501. This can comprise, for example, displaying the predicted portion 504 of the predicted word 503 using a different color (such as red) than the color (such as black) being used to display the user-entered text 501. These teachings will readily accommodate various approaches in these regards, including using differing grayscale shades, differing levels of brightness or contrast, differing background colors or treatment, differing transparency settings, and so forth as desired.

So configured, the displayed predicted content both informs the user of the substance of the prediction and further provides an opportunity for the user to accept that one predicted word. In particular, the user can accept the prediction by asserting the aforementioned button 204. If and as the use does not accept the prediction and keeps entering additional characters these teachings will accommodate presenting different predicted words (again, only one at a time).

Upon detecting 104 a user assertion of that button 204, the control circuit 202 then accepts the one predicted word 503 as a part of the text being entered by the user. This acceptance can include, for example, changing the appearance of the predicted content to now match the previously entered text and moving the text-entry cursor to a position following the accepted word 601 as shown in FIG. 6. By one approach, if desired, this acceptance can further include automatically inserting a space 602 following the accepted word.

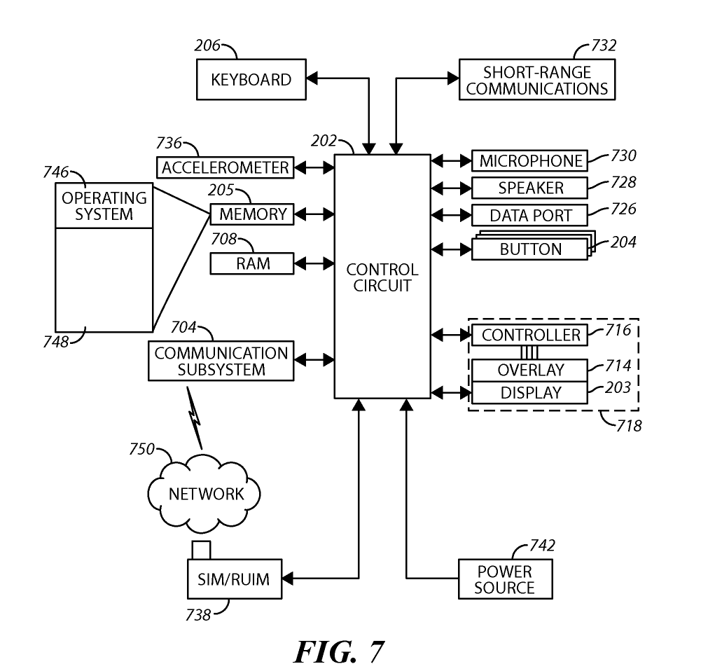

As noted above, the aforementioned apparatus 200 can comprise a portable communications device if desired. FIG. 7 provides a further illustrative example in those regards. Corresponding communication functions, including data and voice communications, are performed through a communication subsystem 704 that operably couples to the aforementioned control circuit 202. The communication subsystem receives messages from and sends messages to a wireless network 750.

The wireless network 750 may be any type of wireless network, including, but not limited to, a wireless data networks, a wireless voice network, or a network that supports both voice and data communications. The control circuit 202 may also operably couple to a short-range communication subsystem 732 (such as an 802.11 or 802.16-compatible transceiver and/or a Bluetooth™-compatible transceiver). To identify a subscriber for network access, the portable electronic device may utilize a Subscriber Identity Module or a Removable User Identity Module (SIM/RUIM) card 738 for communication with a network, such as the wireless network 750. Alternatively, user identification information may be programmed into the aforementioned memory 205.

A power source 742, such as one or more rechargeable batteries or a port to an external power supply, powers the device. The control circuit 202 may interact with an accelerometer 736 that may be utilized to detect direction of gravitational forces or gravity-induced reaction forces. The control circuit 202 also interacts with a variety of other components, such as a Random Access Memory (RAM) 708, the aforementioned button 204, a data port 726, a speaker 728, a microphone 730, and the aforementioned keyboard 206.

The aforementioned display 203 can be disposed in conjunction with a touch-sensitive overlay 714 that operably couples to an electronic controller 716. Together these components can comprise a touch-sensitive display 718 that serves as a graphical-user interface. Information, such as text, characters, symbols, images, icons, and other items may be displayed on the touch-sensitive display 718 via the control circuit 202 if desired.

The touch-sensitive display 718 may employ any of a variety of corresponding technologies including but not limited to capacitive, resistive, infrared, surface acoustic wave (SAW), strain gauge, optical imaging, dispersive signal technology, and/or acoustic pulse recognition-based touch-sensing approaches as are known in the art. If the touch-sensitive display 718 should utilize a capacitive approach, for example, the touch-sensitive overlay 714 can comprise a capacitive touch-sensitive overlay 714. In such a case the overlay 714 may be an assembly of multiple stacked layers including, for example, a substrate, a ground shield layer, a barrier layer, one or more capacitive touch sensor layers separated by a substrate or other barrier, and a cover. The capacitive touch sensor layers may comprise any suitable material, such as indium tin oxide (ITO).

The portable electronic device includes an operating system 746 and software programs, applications, or components 748 that are executed by the control circuit 202 and are stored in the memory 205. Additional applications or programs may be loaded onto the portable electronic device through the wireless network 750, the auxiliary I/O subsystem 724, the data port 726, or the short-range communications subsystem 732.

As a communication device, a received signal such as a text message, an e-mail message, or web page download is processed by the communication subsystem and input to the control circuit 202. The control circuit 202 processes the received signal for output to the display 203. A user may generate data items, for example e-mail messages, that may be transmitted over the wireless network 750 through the communication subsystem. For voice communications, the overall operation of the portable electronic device is similar. The speaker 728 outputs audible information converted from electrical signals, and the microphone 730 converts audible information into electrical signals for processing.

Notwithstanding that such a device makes use of a physical keyboard 206 and/or may have a relatively-small display 203, such a device can employ the present teachings to nevertheless offer the user the benefit of predicted text in a highly intuitive and effective manner. By presenting only one predicted word at a time, in-line with the text being entered, the user is spared the cognitive challenge of locating and assessing a separate listing of multiple candidate predictions. And by permitting the user to employ a dedicated physical (and physically discrete) button (conveniently located, if desired, on a backside of the device) to select a particular prediction the device can permit the typical user to maintain their visual focus on the text-entry field without breaking their attention to effect the selection of a particular predicted word.

The present disclosure may be embodied in other specific forms without departing from its essential characteristics. As but one example in these regards, these teachings will readily accommodate changing the one displayed predicted word for another as a function of passing display time and/or other characters being entered by the user without accepting the proffered prediction.

The described embodiments are to be considered in all respects only as illustrative and not restrictive. The scope of the disclosure is, therefore, indicated by the appended claims rather than by the foregoing description. All changes that come within the meaning and range of equivalency of the claims are to be embraced within their scope.

We claim:

1. An apparatus comprising:
a housing;
a display supported by the housing;
a button that is separate from the display and that is supported by the housing;
a control circuit disposed within the housing and operably coupled to the display and the button, the control circuit configured to:
display, on the display, text being entered by a user;
provide predicted words in response to the text being input by the user;
display only one of the predicted words on the display at a time, in-line with the text being entered by the user, to thereby provide an opportunity for the user to accept the one predicted word;
upon detecting a user assertion of the button, accepting the one predicted word as a part of the text being entered by the user.

2. The apparatus of claim 1 wherein the apparatus comprises a portable communications device.

3. The apparatus of claim 1 wherein the display comprises a touch-sensitive display and the button does not comprise a part of the touch-sensitive display.

4. The apparatus of claim 1 wherein the control circuit is further configured to display the one predicted word on the display when providing the opportunity for the user to accept the one predicted word by displaying a predicted portion of the one predicted word differently than the text being input by the user.

5. The apparatus of claim 4 wherein the control circuit is configured to display the predicted portion of the predicted word differently by using a different color than a color being used to display the text being input by the user.

6. The apparatus of claim 1 further comprising:
an alphanumeric keyboard supported by the housing and operably coupled to the control circuit to provide a way for the user to enter the text;
and wherein the button is separate from the alphanumeric keyboard.

7. The apparatus of claim 1 wherein the button has only one dedicated function.

8. The apparatus of claim 1 wherein the button is disposed on a side of the housing that is opposite the display.

9. The apparatus of claim 1 wherein the button comprises a discrete mechanical button.

10. A method comprising:
by a control circuit:
displaying on a display text being entered by a user;
providing predicted words in response to the text being input by the user;
displaying only one of the predicted words on the display at a time, in-line with the text being entered by the user, to thereby provide an opportunity for the user to accept the one predicted word;
upon detecting a user assertion of a button that is separate from the display, accepting the one predicted word as a part of the text being entered by the user.

11. The method of claim 10 wherein the button has only one dedicated function.

12. The method of claim 10 wherein the control circuit includes a housing and the button is disposed on a side of the housing that is opposite the display.

13. A non-transitory digital memory having computer instructions stored therein, which instructions, when executed by a computer, cause the computer to:
display on a display text being entered by a user;
provide predicted words in response to the text being input by the user;
display only one of the predicted words on the display at a time, in-line with the text being entered by the user, to thereby provide an opportunity for the user to accept the one predicted word;
upon detecting a user assertion of a button that is separate from the display, accept the one predicted word as a part of the text being entered by the user.

14. The non-transitory digital memory of claim 13 wherein the computer instruction to display the one predicted word on the display when providing the opportunity for the user to accept the one predicted word comprises causing the computer to display a predicted portion of the one predicted word differently than the text being input by the user.

15. The non-transitory digital memory of claim 14 the computer instruction to display the predicted portion of the predicted word differently comprises causing the computer to use a different color than a color being used to display the text being input by the user.
